(19) United States
(12) Patent Application Publication
(10) Pub. No.: US 2008/0270759 A1
(43) Pub. Date: Oct. 30, 2008

(54) Computer Having Dynamically-Changeable Instruction Set in Real Time

(75) Inventor: Jin-hyeock Im, Seoul (KR)

Correspondence Address: FOLEY & LARDNER LLP, 777 EAST WISCONSIN AVENUE, MILWAUKEE, WI, 53202-5306, US

(73) Assignee: Chips & Media, Inc.

(21) Appl. No.: 11/884,506

(22) PCT Filed: Aug. 25, 2006
(86) PCT No.: PCT/KR06/03364

§ 371 Date: Aug. 16, 2007

(30) Foreign Application Priority Data
Aug. 31, 2005 (KR) 10-2005-0080533

(51) Int. Cl. G06F 9/30

(52) U.S. Cl. 712/208; 712/E09.016

(57) ABSTRACT

A computer allows dynamic change of an instruction set during a real-time execution. The computer includes a CPU (Central Processing Unit) having an instruction fetch unit for fetching an instruction from a memory, an instruction decoding unit for generating a predetermined control code corresponding to the instruction fetched by the instruction fetch unit, and an arithmetic logic unit operated by the control code. The instruction decoding unit includes a basic instruction decoding unit for generating a control code for a basic instruction set; and a dynamic instruction decoding unit for generating another control code different from the control code corresponding to an instruction of the basic instruction set, or generating a control code corresponding to an instruction not existing in the basic instruction set. An instruction stored in the dynamic instruction decoding unit or a corresponding control code is configured to be changeable during execution in real time.

### TECHNICAL FIELD

The present invention relates to an instruction set of a computer, and more particularly to an instruction set structure of a computer having an instruction set allowing to exhibit the best instruction execution capability with an optimal memory capacity.

### BACKGROUND ART

Generally, a computer executes a given program in a way that a CPU (Central Processing Unit) reads and decodes one or several instructions, translated into a machine language and stored in a main memory, and then generates a corresponding control code to be supplied to a corresponding hardwired logic such as an arithmetic logic unit so that the hardwired logic is operated.

Here, one instruction is composed of an OP code and one or more operands, and it is classified into 0-operand instruction, 1-operand instruction, and 2,3-operand instruction depending on the number of operands. Java processor is an example of using 0-operand instruction, DSP (Digital Signal Processor) is an example of using 1-operand instruction, and most of general computers use 2,3-operand instruction.

Meanwhile, most computers may be classified into RISC (Reduced Instruction Set Computer) having a simple and small number of instruction sets, and CISC (Complex Instruction Set Computer) having a great number of instruction sets corresponding to a high-level programming language as directly as possible, depending on a configuration method of instruction sets. There are proposed various kinds of computers depending on instruction sets since they adopt different ways to efficiently process a specific job (i.e., program). That is to say, when a computer conducts a specific job, there are generally required three resources: a memory, a CPU and time for the job, and thus the computer is obliged to take different ways for optimized resource utilization according to each specific job. In this point, there have been many changes in instruction sets, and accordingly various kinds of computers have been developed with different specifications.

Also, a method for decoding an instruction and generating a control code (or, control codes) is classified into three types. The first type is a micro coding method, by which instructions are translated into a series of control codes according to contents previously stored in ROM (Read Only Memory) of the CPU. In the second type, parallel control codes are generated in a way that PLA (Programmable Logic Array) is used instead of ROM for translation into a control code, which may reduce an entire execution time of program in comparison to the micro coding method. In addition, the third type is to translate an instruction into a control code by means of software, in which a small micro CPU is provided and then a translation software operated on the small micro CPU translates an instruction in real time to generate a control code. If software is used, flexibility is enhanced but more time is required for translation rather than hardware.

However, some times, most computers should conduct jobs appropriate for instruction sets not possessed by them, not conducting only jobs (programs) suitable for their own instruction sets. Thus, there have been proposed a multi instruction set processor having two instruction sets and generating a control code with two decoders for respective instruction sets, and a processor for converting an instruction set, not possessed, into an instruction of an instruction set, possessed, by means of software or converter and then generating a control code (see Korean Patent No. 315739, Korean Patent No. 327777, Korean Laid-open Patent Publication No. 2001-53241, Korean Patent No. 270947, and so on). However, such methods result in inefficiency and high expenses since two instruction decoders (ROMs or PLAs) are substantially required. In addition, in case of using software, the time taken for decoding an instruction is increased at least doubly as mentioned above. Moreover, these methods cannot allow various modifications, such as changing meaning of only some required instructions (or, generating a control code different from an original one) or limiting the execution.

Meanwhile, there has also been proposed an EISC (Extended Instruction Set Computer) that increases a length of an operand as required by using an extension register and an extension flag. However, this EISC changes only the length of an operand with respect to the same OP code, so it cannot be considered as a true change of an instruction set.

Thus, there is still a need for a computer configured to allow correction or change of an instruction set, for example changing meaning of some required instructions or adding an instruction, at a low expense and at high speed, during real-time execution.

### DISCLOSURE OF INVENTION

### Technical Problem

The present invention is designed to meet the above requirements, and therefore it is an object of the present invention to provide a computer having a dynamically-changeable instruction set, which may change an instruction set in real time.

### Technical Solution

In order to accomplish the above object, the present invention provides an instruction decoding unit, which includes a basic instruction decoding unit for decoding basic instructions, and a dynamic instruction decoding unit for decoding instructions dynamically changed during a real-time execution, and also generates a control code (or, control codes) corresponding to the dynamically changed instruction.

That is to say, the computer according to the present invention includes a CPU (Central Processing Unit) having an instruction fetch unit for fetching an instruction from a memory, an instruction decoding unit for generating a predetermined control code corresponding to the instruction fetched by the instruction fetch unit, and an arithmetic logic unit operated by the control code, and the instruction decoding unit includes a basic instruction decoding unit for generating a control code for a basic instruction set; and a dynamic instruction decoding unit for generating another control code different from the control code corresponding to an instruction of the basic instruction set, or generating a control code corresponding to an instruction not existing in the basic instruction set, wherein an instruction stored in the dynamic instruction decoding unit or a corresponding control code is configured to be changeable during execution in real time.

Here, the dynamic instruction decoding unit is preferably composed of CAM (Content Addressable Memory) since it allows change during the real-time execution and ensures high-rate operation.

In more detail, the CAM composing the dynamic instruction decoding unit includes a memory device array for storing a changed instruction set, a comparator for comparing an input instruction code with the changed instruction set stored in the memory device array, and a code register for storing a control code to be output in case the comparison result is matched.

In addition, preferably, an instruction code fetched from the instruction fetch unit and status information of each block in the CPU including the arithmetic logic unit are input together to the basic instruction decoding unit and the dynamic instruction decoding unit. Also, the CAM composing the dynamic instruction decoding unit preferably further includes a masking register for masking a specific bit of the input instruction code and status information for the purpose of comparison.

### BRIEF DESCRIPTION OF THE DRAWINGS

Other objects and aspects of the present invention will become apparent from the following description of embodiments with reference to the accompanying drawing in which:

FIG. 1 is a block diagram schematically showing an instruction decoding unit in a CPU of a computer according to an embodiment of the present invention;

FIG. 2 is a detailed block diagram showing a dynamic instruction decoding unit of the instruction decoding unit shown in FIG. 1; and

FIG. 3 is a block diagram showing each CAM (Content Addressable Memory) of the dynamic instruction decoding unit shown in FIG. 2.

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

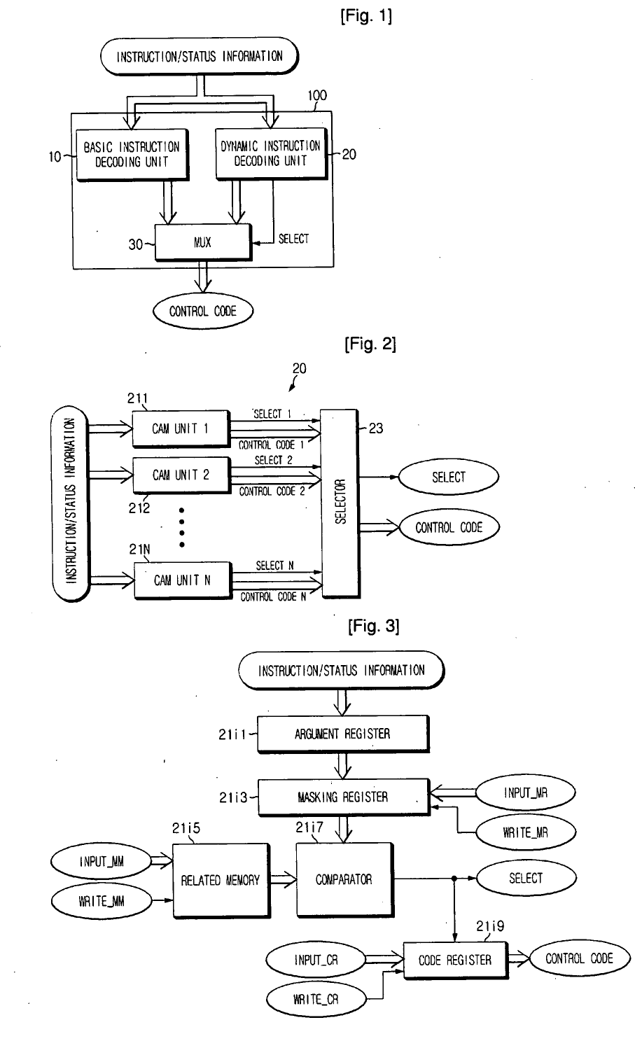

FIG. 1 is a block diagram showing an instruction decoding unit in a CPU of a computer according to an embodiment of the present invention.

Referring to FIG. 1, the instruction decoding unit 100 of a computer according to this embodiment includes a basic instruction decoding unit 10, a dynamic instruction decoding unit 20, and a multiplexer 30. The basic instruction decoding unit 10 decodes instructions included in a basic instruction set and then outputs a control code corresponding to them, and it is generally composed of ROM or PLA. The dynamic instruction decoding unit 20 decodes instructions included in a dynamically changed instruction set according to the present invention and then outputs a control code corresponding to them, and it is composed of CAM in this embodiment. In addition, the multiplexer 30 selectively outputs the control code, output as an instruction decoding result of each instruction decoding unit 10 or 20, according to a select signal SELECT.

Meanwhile, seeing FIG. 1, the instruction decoding unit of this embodiment appears to be similar with a conventional computer having two instruction sets, in the point that two parallel instruction decoding units are provided in this embodiment. However, the dynamic instruction decoding unit 20 of this embodiment is not a decoding unit for a fixed one instruction set, but a decoding unit for an instruction complementarily added or changed with respect to a basic instruction set, so the processor having the instruction decoding unit 100 of this embodiment is entirely different from a conventional multi instruction set processor. In addition, the dynamic instruction decoding unit 20 of this embodiment is entirely different from a converter (whether it is hardware or software) for converting one instruction set into another instruction set, since it decodes an instruction by itself and then outputs a control code in parallel with the basic instruction decoding unit 10. In addition, in this point, the dynamic instruction decoding unit 20 of this embodiment is different from an extension register for temporarily storing an extended operand of a conventional EISC and an extension flag indicating that an operand is extended.

FIG. 2 is a detailed block diagram showing the dynamic instruction decoding unit 20 shown in FIG. 1. Referring to FIG. 2, the dynamic instruction decoding unit 20 of this embodiment includes N number of parallel CAM units 211, 212, . . . , 21N, and a selector 23. For one or multiple dynamic instruction codes, each CAM unit 21i stores its instruction set and control codes corresponding to them, and also outputs a corresponding control code in case it is matched with a select signal SELECT 1, SELECT 2, . . . , SELECT N that indicates correspondence with an instruction to be input. The selector is a kind of multiplexer that selectively outputs a control code, output from the CAM unit storing a matched dynamic instruction, according to a select signal output from a plurality of CAM units 21i.

Meanwhile, the basic instruction decoding unit 10 has the same configuration as an instruction decoding unit in a computer commonly having one instruction set, so it is not described in detail here.

FIG. 3 is a detailed block diagram showing each CAM unit 21i shown in FIG. 2. Here, each CAM unit 21i is illustrated to store one instruction code and a corresponding control code, as an example. Referring to FIG. 3, the CAM unit 21i composing the dynamic instruction decoding unit of this embodiment basically has the same configuration as a common CAM, except that it additionally has a code register 21i9 storing a control code corresponding to each instruction of the CAM unit.

Specifically, each CAM unit 21i includes a memory device 21i5 for storing a dynamically changed instruction, an argument register 21i1 for temporarily storing an input instruction code and status information, described later in detail, a masking register 21i3 for extracting a portion to be compared among the input instruction code and the status information, a comparator 21i7 for comparing an unmasked portion of the input instruction and the status information with the dynamically changed instruction stored in the memory device 21i5 so as to determine correspondence between them, and a code register 21i9 for storing a control code corresponding to the changed instruction stored in the memory device 21i5. Meanwhile, the bit-unit configuration of the comparator 21i7, or so-called matching logic, and the memory device 21i5 have the same configuration as a general CAM, so they are not described in detail here.

Now, the operation of the instruction decoding unit 100 configured as mentioned above according to this embodiment will be described in detail with reference to FIGS. 1 to 3.

First, an instruction fetch unit (not shown) reads one or plural instruction codes from a main memory (not shown) in a fetch cycle and then inputs the instruction codes to the instruction decoding unit 100. The instruction code is composed of an OP code and 0 or at least one operand. Meanwhile, the status information indicating a current status of each block of the CPU including the arithmetic logic unit (not shown) is input to the instruction decoding unit 100 together at this time. The obtained instruction code and status information is input to the basic instruction decoding unit 10 and the dynamic instruction decoding unit 20 together in parallel. Thus, there is no need for a separate converting process conducted by a conventional converter.

Subsequently, in an instruction decoding cycle, the basic instruction decoding unit 10 and the dynamic instruction decoding unit 20 decode instruction codes and status information at the same time in parallel, and then output corresponding control codes. Specifically, the basic instruction decoding unit 10 composed of ROM or PLA decodes an instruction according to a common instruction decoding method and then outputs a control code, so it is not described in detail here.

However, in the present invention, in case a dynamically changed instruction code is input, an instruction corresponding to the code may not exist in the basic instruction decoding unit 10, and also, though there exists a corresponding instruction, a changed control code different from an original one should be a final output of the instruction decoding unit 100. Thus, the changed control code that is an output of the dynamic instruction decoding unit 20 should have priority. That is to say, in case the dynamic instruction decoding unit 20 decodes an instruction with the input instruction code and status information and then finds that there exists a corresponding instruction, the dynamic instruction decoding code 20 outputs an activated select signal SELECT together with the corresponding changed control code. In addition, the multiplexer 30 outputs the control code, output from the dynamic instruction decoding unit 20, as an output of the instruction decoding unit 100 according to the activated select signal SELECT of the dynamic instruction decoding unit 20 regardless of an output of the basic instruction decoding unit 10. Meanwhile, in case there is no matching instruction code and status information as a decoding result of the dynamic instruction decoding unit 20, the dynamic instruction decoding unit 20 outputs an inactivated select signal without outputting a control code, and a control code output from the basic instruction decoding unit 10 is output as an output of the instruction decoding unit 100.

The instruction decoding process of the dynamic instruction decoding unit 20 will be described in more detail as follows.

First, the instruction code and the status information input to each CAM unit 21i of the dynamic instruction decoding unit 20 are temporarily stored in the argument register 21i1, and a portion to be compared is extracted by the masking register 21i3. That is to say, the masking register 21i3 is a register having the same size as the argument register 21i1. In the instruction code and the status information, the masking register 21i3 sets a bit used for comparison into 1 and also sets a bit not used in the comparison (or, a bit that the masking register does not care) into 0 so that a desired portion is extracted from the instruction code and the status information. At this time, the portion used for comparison may be an OP code in case the instruction itself is an added instruction that does not exist in a basic instruction set; status information such as exception or interrupt information in case the instruction itself is identical but a specific execution should be changed according to the status information in the system; an operator and a part of operand; or a part of the status information. In addition, on occasions, it may be the entire instruction code and status information, and this case is substantially identical to a case that the masking register 21i3 does not exist.

Meanwhile, a changed instruction code and status information for a basic instruction set is already stored in the memory device 21i5, and the comparator (or, a matching logic) 21i7 compares it with the input instruction code and status information masked by the masking register 21i3. If they are matched in the comparison, a select signal SELECT is output, and the control code stored in the code register 21i9 is output at the same time.

According to the above process, a control code corresponding to the changed instruction with respect to a basic instruction set is output, and each block in the CPU such as an arithmetic logic unit (not shown) is operated according to the control code, thereby executing the changed instruction.

Now, the operation of dynamically changing an instruction in real time is explained. As mentioned above, the changed instruction is stored in the memory device 21i5, and a corresponding control code is stored in the code register 21i9. At this time, in order to dynamically change the instruction set in real time, it is required to access the memory device 21i5 and the code register 21i9 during the real-time execution and update their contents. For this purpose, a specific instruction allowing to input a desired data to the memory device 21i5 and the code register 21i9 is included in the basic instruction set, and then a necessary change is made in a program code, translated (or, compiled) into a machine language, using the specific instruction. Here, a compiler, namely software, takes a charge of translating a program, made using a high-level language, into a machine language and also inserting the specific instruction therein as required, and it is not an essential part of the present invention and thus not described in detail here.

The specific instruction allowing change of a basic instruction set may be composed of a specific OP code and an operand having contents to be changed. In addition, ROM or PLA of the basic instruction decoding unit 10 stores a control code corresponding to the specific instruction. This control code activates a writing signal WRITE_mM of the memory device 21i5, inputting the contents of the operand of the specific instruction to a data input INPUT_MM of the memory device 21i5, at the same time activates a writing signal WRITE_CR of the code register 21i9, and inputs a desired (or, changed) control code into a data input INPUT_CR of the code register 21i9. Thus, it is possible to dynamically change the instruction set in real time using the specific instruction as a basic instruction.

Meanwhile, contents of the masking register 21i3, namely a mask for extracting a portion to be compared among the input instruction code and status information, may also be dynamically changed in the similar way to the memory device 21i5 and the code register 21i9. That is to say, the contents of the masking register 21i3 may be dynamically changed during the real-time execution by activating a writing signal WRITE_MR of the masking register 21i3 and inputting a desired mask into a data input INPUT_MR.

As mentioned above, according to the embodiment of the present invention, it is possible to optimize size and execution time of a program code by dynamically changing an instruction set during the real-time execution. However, the present invention is not limited to the above embodiment, but various modifications are possible within the principle and spirit of the present invention.

For example, the multiplexer 30 and the selector 23 of the former embodiment may be replaced with a simple OR gate, and the masking register 21i3 may be excluded such that the instruction code and the status information are entirely compared with the contents stored in the memory device 21i5. In addition, in the former embodiment, the dynamic instruction decoding unit 20 has been illustrated and explained to include N number of parallel CAM units 211, 212, . . . , 21N, but it is also possible to include only one CAM unit.

Therefore, the claimed right of the invention should be interpreted to include various changes and modifications within the equivalent scope of the appended claims.

### INDUSTRIAL APPLICABILITY

According to the present invention as described above, it is possible to optimize size and execution time of a program code at the same time by dynamically changing an instruction set in real time. That is to say, since a part of the basic instruction set is dynamically executed during the real-time execution, it is possible to optimize size and execution time of a program code according to the nature of job (or, program) to be conducted at a much lower cost rather than a processor having two instruction sets or a converter between instruction sets. In addition, since one instruction code may be entirely changed dynamically, the present invention allows much more diverse and flexible change rather than EISC that extends only a length of an operand.

In addition, according to the present invention, it is possible to instantly add a function required in the working spot, so the present invention may be effectively used to correct a bug, as well as improve functions.

1. A computer comprising a CPU (Central Processing Unit) having an instruction fetch unit for fetching an instruction from a memory, an instruction decoding unit for generating a predetermined control code corresponding to the instruction fetched by the instruction fetch unit, and an arithmetic logic unit operated by the control code,
wherein the instruction decoding unit includes:
a basic instruction decoding unit for generating a control code for a basic instruction set; and
a dynamic instruction decoding unit for generating another control code different from the control code corresponding to an instruction of the basic instruction set, or generating a control code corresponding to an instruction not existing in the basic instruction set,
wherein an instruction stored in the dynamic instruction decoding unit or a corresponding control code is configured to be changeable during execution in real time.

2. The computer according to claim 1, wherein the dynamic instruction decoding unit comprises CAM (Content Addressable Memory).

3. The computer according to claim 2, wherein the CAM composing the dynamic instruction decoding unit includes a memory device array for storing a changed instruction set, a comparator for comparing an input instruction code with the changed instruction set stored in the memory device array, and a code register for storing a control code to be output in case the comparison result is matched.

4. The computer according to claim 1, wherein an instruction code fetched from the instruction fetch unit and status information of each block in the CPU including the arithmetic logic unit are input together to the basic instruction decoding unit and the dynamic instruction decoding unit.

5. The computer according to claim 2, wherein the CAM composing the dynamic instruction decoding unit further includes a masking register for masking a specific bit of the input instruction code and status information for the purpose of comparison.
